(19) United States
(12) Patent Application Publication
(10) Pub. No.: US 2007/0051906 A1
(43) Pub. Date: Mar. 8, 2007

(54) Method and apparatus for determining the resistance of materials to light and corrosives

(76) Inventors: Patrick J. Brennan, Richfield, OH (US); William R. Wurst, Elyria, OH (US); Danny J. Fayak, Wellington, OH (US); Gregory R. Fedor, Bay Village, OH (US); Jeffrey A. Quill, Cleveland Heights, OH (US)

Correspondence Address: FAY SHARPE LLP, 1100 SUPERIOR AVENUE, SEVENTH FLOOR, CLEVELAND, OH, 44114, US

(21) Appl. No.: 10/573,320

(22) PCT Filed: Mar. 1, 2004
(86) PCT No.: PCT/US04/06123

§ 371 Date: Mar. 24, 2006

Related U.S. Application Data
(60) Provisional application No. 60/505,669, filed on Sep. 24, 2003.

(51) Int. Cl. G01J 3/10

(52) U.S. Cl. 250/504 R

(57) ABSTRACT

An accelerated weather testing apparatus includes a test chamber, a lamp (16), a dispenser (18, 20), and a specimen support (14). The lamp is capable of generating UV radiation and directing the radiation towards the specimen support. The dispenser connects to an associated liquid source to dispense either water or acid, or both. The specimen support is disposed in the test chamber below the lamp and the dispenser.

### BACKGROUND OF THE INVENTION

Weather can damage products. The damage includes fading, yellowing, color change, strength loss, embrittlement, oxidation, gloss loss, cracking, hazing and chalking, to name a few. Not only can sunlight cause damage to products, rain, including acid rain, can also damage products.

Most automobiles include a clear coating overtop a painted substrate, which can be metal or plastic. Damage to the automotive coating can occur from acid rain. “Water spot” etches can be formed from acid catalyzed hydrolysis that occurs in areas where acid rain occurred and temperatures were high. Etches are formed when material is lost from the surface of the coating. When enough bonds are broken, polymer molecules or fragments become detached from the rest of the coating and are washed away.

Attempts have been made at developing laboratory techniques to predict etch resistance of automotive clear coats. Accelerated weather testing apparatus have been developed to predict the affects of weather on coated substrates. Such accelerating weather testing apparatus include a test chamber into which a specimen is placed. Known accelerating weather testing apparatus do not accurately simulate the effects of acid rain and sunlight on coated substrates. Accordingly, it is desirable to provide such a weather testing apparatus, as well as methods for testing the performance of test specimens in such an apparatus.

### SUMMARY OF THE INVENTION

Even though an accelerated weather testing apparatus is described with reference to etch resistance of a coating in the presence of acid rain, the apparatus described below is not limited to testing specimens only for acid rain performance. The apparatus can be used to examine the effects of light and/or corrosive solutions on a number of products including wood, roofing, textiles, inks, adhesives, sealants, packaging, plastics, metal, etc. The weather testing apparatus described below is amenable to other applications as well and is limited only by scope of the appended claims.

An accelerated weather testing apparatus includes a test chamber, a lamp, a dispenser, and a specimen support. The lamp is capable of generating UV radiation and directing the radiation towards the specimen support. The dispenser connects to an associated liquid source to dispense either water or an acid solution, or both. The specimen support is disposed in the test chamber below the lamp and the dispenser. The specimen support is configured such that it supports a test specimen in at least a substantially horizontal orientation.

A method for generating the effect of a corrosive solution on a test specimen in an accelerated weathering apparatus is also provided. The method includes positioning a test specimen at least substantially horizontally on the specimen support. The method further includes wetting the test specimen. The method further includes selectively emitting radiation from the lamp such that the radiation contacts the test specimen. The method also includes controlled drying of the test specimen.

A method for accelerated weathering of a test specimen in an accelerated weathering apparatus is provided. The method includes positioning a test specimen in the test chamber, selecting a desired irradiance, selecting a desired chamber air temperature, selecting a desired black panel temperature, selecting a desired chamber relative humidity, sensing the black panel temperature, sensing the chamber air temperature and sensing the chamber relative humidity. The method further includes comparing the sensed black panel temperature to the desired black panel temperature. The method also includes comparing the sensed chamber air temperature to the desired chamber air temperature. The method also includes adjusting the blower system in response to the previously mentioned comparing steps.

### BRIEF DESCRIPTION OF THE DRAWINGS

FIG. 1 is a diagrammatic illustration of an accelerated weathering apparatus;

FIG. 2 is a diagrammatic illustration of the accelerated weathering apparatus of FIG. 1 having relative humidity control and some components removed for clarity;

FIG. 3 is a diagrammatic illustration of a blower controller for use with the accelerated weathering apparatus of FIG. 1;

FIG. 4 is flow chart illustrating a method of controlling a multiple blower system for use with the accelerated weathering apparatus of FIG. 1;

FIG. 5 is a flow chart illustrating another method of controlling a multiple blower system for use with the accelerated weathering apparatus of FIG. 1;

FIG. 6 is a flow chart illustrating another embodiment for controlling a multiple blower system for use with the accelerated weathering apparatus of FIG. 1;

FIG. 7 is a schematic diagram of plumbing for use with the accelerated weathering apparatus of FIG. 1; and

FIG. 8 is a view of a test specimen having a plurality of droplets formed on the test specimen in accordance with a disclosed method.

### DETAILED DESCRIPTION

An accelerated weathering apparatus 10 includes a test chamber 12 that can include or communicate with a number of different components and systems, which will be described in more detail below. The accelerated weathering apparatus 10 includes a specimen support 14 disposed in the chamber 12, a lamp 16 that directs light toward the specimen support 14, and fluid dispensers 18 and 20 that dispense fluid towards the specimen support 14.

The test chamber 12 is large enough to hold a plurality of test samples. The test chamber 12 can also be large enough to hold lamps 16 and plumbing leading to the fluid dispensers 18 and 20. The test chamber can also be large enough to allow adequate space between the lamps 16 and the test specimens as well as allowing for adequate space between the fluid dispensers 18 and 20 and the test specimens. Adequate space allows for more uniform distribution of radiation and liquid onto test specimens.

The specimen support 14 is situated below the lamps 16 and the fluid dispensers 18 and 20. The specimen support can be a rack or tray large enough to hold a plurality of specimens. The specimen support, preferably, does not include upwardly extending sidewalls that would impede the flow of liquid running off of the samples. Alternatively, the specimen support includes drain holes to allow excess liquid to freely run off of the specimens so that the specimens are not submerged in liquid as they dry off. The specimen support is designed to support test specimens in a substantially horizontal orientation. Such a substantially horizontal orientation is preferably less than 15 degrees from horizontal, and more preferably less than 10 degrees from horizontal. Such a horizontal orientation advantageously simulates the orientation of the hood, top, or trunk of an automobile. The horizontal orientation promotes the formation of water droplets on the test specimens, which more accurately simulates the hood, top, or trunk of an automobile in that rain does not easily run off those substantially flat horizontal surfaces so that the droplets dry in place. The specimen support may be stationary or can move, for example rotate.

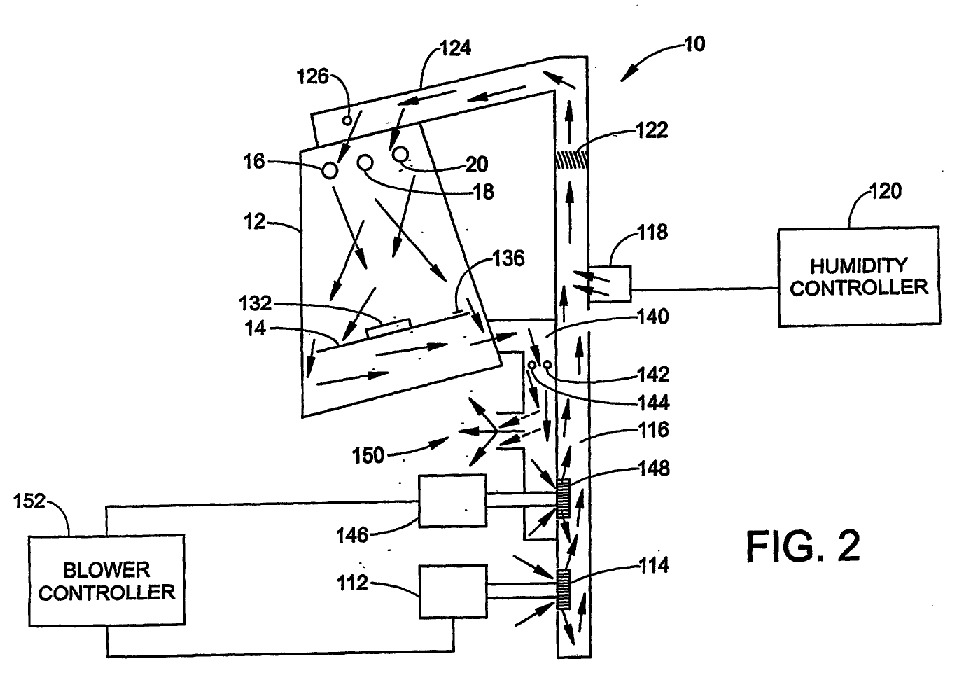

The lamp 16, which can be a xenon lamp or other suitable lamp, mounts near reflectors 22 and infrared (IR) mirrors 24. Furthermore, the lamp 16 can be filtered using filters 26 to simulate the spectrum that is emitted by sunlight. Such filters and filtering systems are known in the art. One lamp is shown schematically in FIG. 2. Plural lamps 16 may also be used.

An irradiance controller 28 adjusts the lamp 16 output. The irradiance controller 28 can include a dimmer that controls the amount of power delivered to the lamp 16 to adjust the output. The irradiance controller 28 communicates with the lamp 16 and an irradiance sensor of the lamp 30, which measures the amount of light in the test chamber 12 and provides this information to the irradiance controller 28. The irradiance controller 28 can adjust the lamp output in accordance with values set by a user via an input control panel (not shown). An accelerated weathering apparatus including examples of an irradiance controller and an input control panel are shown for example in U.S. Pat. No. 5,206,518, hereby incorporated by reference.

A ballast 32 controls the power delivered to the lamp 16. The ballast 32 can communicate with the lamp 16 through a switch and timer mechanism 34 to control how long power is delivered to the lamp 16. The ballast 32 also communicates with the irradiance controller 28 to control the power delivered to the lamp in response to the input of the user. By using the switch and timer mechanism 34, the lamp 16 can be cycled, i.e. turned off and on to simulate day or night conditions. The switch and timer mechanism 34 can receive input from an input panel (not shown) so that the user can set specific cycle times.

In addition to subjecting the test specimen to radiation, the specimens can also be subjected to corrosive solutions. Two dispensers 18 and 20 are shown and described; however, one dispenser or a plurality of dispensers can be provided. The wetting of the specimens will be described with reference to apparatus that spray liquid onto the specimens; however, the specimen can be wet in any conventional manner. For example, the specimen can be immersed in solution. To immerse the specimen, the specimen can be placed in a tray having side walls and solution can be introduced into the tray to immerse the specimen.

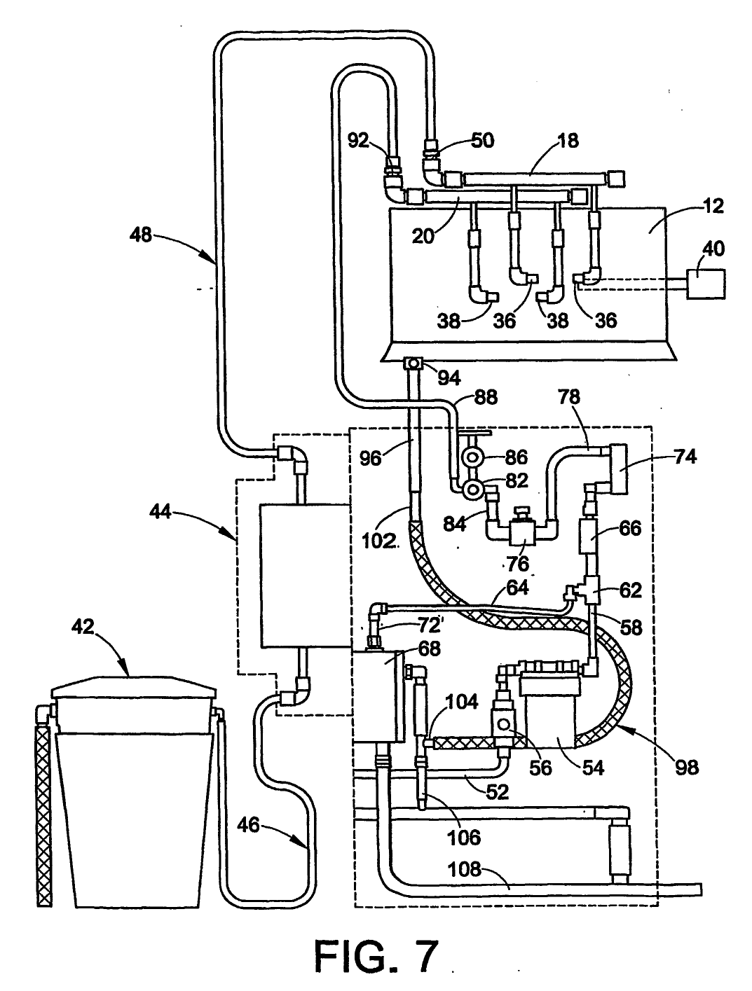

With reference to FIG. 7, the first dispenser 18 is in fluid communication with a corrosive solution source, which can include an acid solution to simulate acid rain, as well as other corrosive solutions including a basic solution, salts, organics, and other chemicals. The second dispenser 20 is in fluid communication with a “clean” water source that can include deionized municipal water, as well as typical tap water, distilled water, etc. The first dispenser includes a spray bar assembly that includes spray nozzles 36 attached at a free end thereof. Similarly, the second dispenser includes a spray bar assembly having a spray nozzle 38 attached at a free end thereof. The nozzles 36 and 38 can include valves (not shown) and the like to regulate the flow rate of liquid through the nozzles. In one embodiment, the nozzles 36 and 38 spray a mist. The mist can be sprayed for a long enough time on the test specimens such that water droplets of a desired diameter form on the test specimens. In an alternative embodiment, the nozzles 36 and 38 are adapted to emit large droplets that fall on the test specimens, similar to the size droplets in a rain storm. The nozzles can also be configured to dispense liquid on a size that is between a mist and large droplets, or to provide a stream similar to a faucet. A timer 40 is in communication with each of the dispensers 18 and 20 to control the length of time each dispenser dispenses liquid and the time interval between dispenses. The timer 40 can communicate with an input panel (not shown) so that a user can input the amount of time each dispenser dispenses liquid and the time interval between dispenses. Also, the valve (not shown) in each nozzle can communicate with the input panel to control the size droplet dispensed from the nozzle.

Describing the flow of the corrosive solution, a reservoir 42 stores the corrosive solution. The reservoir 42 communicates with a pump assembly 44 through a pipe 46. The pump assembly 44 pumps the corrosive solution through a pipe 48 towards a check valve 50 and the first dispenser 18. The first dispenser 18 includes the nozzles 36, which are disposed in the test chamber 12. The pipes and components in the flow path of the corrosive solution are constructed of suitable material such that they do not degrade in the presence of the corrosive solutions flowing through them.

Describing the flow of water from a water source (not shown), the water passes through a pipe 52 and communicates with a water filter 54 through a water inlet valve 56. The water is filtered in the water filter 54 and then passes into a pipe 58. Pipe 58 connects to a tee 62 where a pipe 64 connects at one outlet of the tee 62 and a flow switch 66 connects at the other outlet of the tee. The flow switch 66 controls the amount of water passing through it, sending any excess water through pipe 64 via tee 62. Pipe 64 connects to a water feed assembly 68 via pipe 72. The flow switch 66 communicates with a flow meter 74. The flow meter 74 measures the amount of water delivered to the second dispenser 20. The flow meter 74 communicates with a solenoid valve 76 via pipe 78. The solenoid valve 76 controls the amount of water delivered to the second dispenser 20. The solenoid valve 76 communicates with a pressure regulator 82 via pipe 84. A pressure gauge 86 is provided to measure the pressure of the water passing through the pressure regulator 82. The pressure regulator 82 regulates the pressure of the water delivered to the second dispenser 20. The pressure regulator 82 communicates with a pipe 88 which communicates with the second dispenser 20 via a check valve 92. The second dispenser 20 includes the nozzles 38, which are disposed in the test chamber 12.

The chamber 12 includes a drain 94 to remove the liquid from the chamber. The drain 94 connects with a pipe 96. The pipe 96 communicates with a drain pipe 98 through a coupling 102. The drain pipe 98 connects to a tee 104 that communicates with an outlet pipe 106 through a first outlet and the water feed assembly 68 via a second outlet. The water feed assembly supplies water to a humidifier, which will be described in more detail below, via a pipe 108.

To control the drying of the specimens in the test chamber 12, a conditioning system for controlling air conditions in the test chamber is provided. One embodiment of the conditioning system is shown including multiple blowers in communication with the test chamber 12. Nevertheless, other conditioning systems, for example one having a single blower and a damper, can also be used to control the air conditions inside the test chamber 12.

With reference to FIG. 2, the accelerated weathering apparatus 10 includes a fresh air blower 112, which draws room air or fresh air through a fresh air inlet 114 into an air mixing duct 116. The fresh air travels through the air mixing duct 116 where a humidifier 118, controlled by a humidity controller 120, adds additional humidity to the air as needed. Air heater 122 increases the temperature of the air, if needed, before the air flows into a chamber inlet duct 124. The plurality of arrows present in FIG. 2 are to illustrate the pattern of air flow throughout the accelerated weathering apparatus.

Optionally, a first air temperature sensor 126 measures the air temperature, the operation of which will be described more fully below, before passing into a test chamber 12. The air flows into the test chamber and over one or more samples 132 disposed on the specimen support 14. Preferably, a black panel temperature 136 sensor mounts to the specimen support 14.

After passing around the specimen support 14, the air flows out of the test chamber 12 and into an exhaust duct 140, where a second chamber air temperature sensor 142 and a chamber humidity sensor 144 measure the exhaust air temperature and either relative humidity or wet bulb temperature. At this point, a recirculation air blower 146 optionally draws a portion of the air from the exhaust duct back into the air mixing duct 116 through a recirculated air inlet 148, where it mixes with the fresh air drawn in by the fresh air blower 112, for circulation through the system again. Air that is not drawn back into the system through the recirculation air blower 146 flows out of the system through an exhaust 150. As is described more fully below, a blower controller 152 controls the speeds of the fresh air blower 112 and the recirculation air blower 146 in order to control both the chamber air and black panel temperatures. While FIG. 2 illustrates an embodiment containing two air blowers, it is to be appreciated that the weathering apparatus can include other multiple-blower systems, or as mentioned above a single blower and a damper.

Prior to performing a test in the weathering apparatus 10, an operator specifies or sets the applicable test parameters. Preferably, the desired irradiance (IRR_{SP}) and at least one of the following: (i) the desired black panel temperature (BPT_{SP}), and (ii) desired chamber air temperature (CAT_{SP}) are set. In addition, the desired relative humidity (RH_{SP}) may be selected by the operator if the test to be performed requires such. It is to be appreciated that if only one of the CAT and BPT is specified, the other is estimated, either by formula or through a lookup table.

Artisans will appreciate that actual chamber air temperature (CAT) cannot be measured directly in the test chamber 12, because of the heating effect of the radiation from the lamps 16. Therefore, chamber air temperature is typically measured at the chamber outlet using the second chamber air temperature sensor 142. Alternatively, the actual chamber air temperature or dry bulb temperature is measured using an average of the temperature readings from the first chamber air sensor 126, which is located at the test chamber inlet, and the temperature reading of the second chamber air temperature sensor 142 located at the chamber outlet. It is to be appreciated that either a weighted or simple average of the temperatures from the first and second chamber air temperature sensors may be employed.

In one embodiment, the black panel temperature sensor 136 includes an uninsulated black panel sensor, which measures actual black panel temperature (BPT). Alternately, the black panel temperature sensor 136 includes an insulated black panel sensor which measures actual black standard temperature (BST). It is to be appreciated that in the below-described control methods, BPT and BST may be used interchangeably, depending on the requirements of the weathering test being performed. In one embodiment, the chamber humidity sensor 144 includes a conventional relative humidity sensor. In an alternate embodiment, relative humidity is calculated or looked up based on measurements from a wet-bulb temperature sensor, along with temperature readings from one or both of the chamber air temperature sensors 126, 142, which provide dry bulb temperatures.

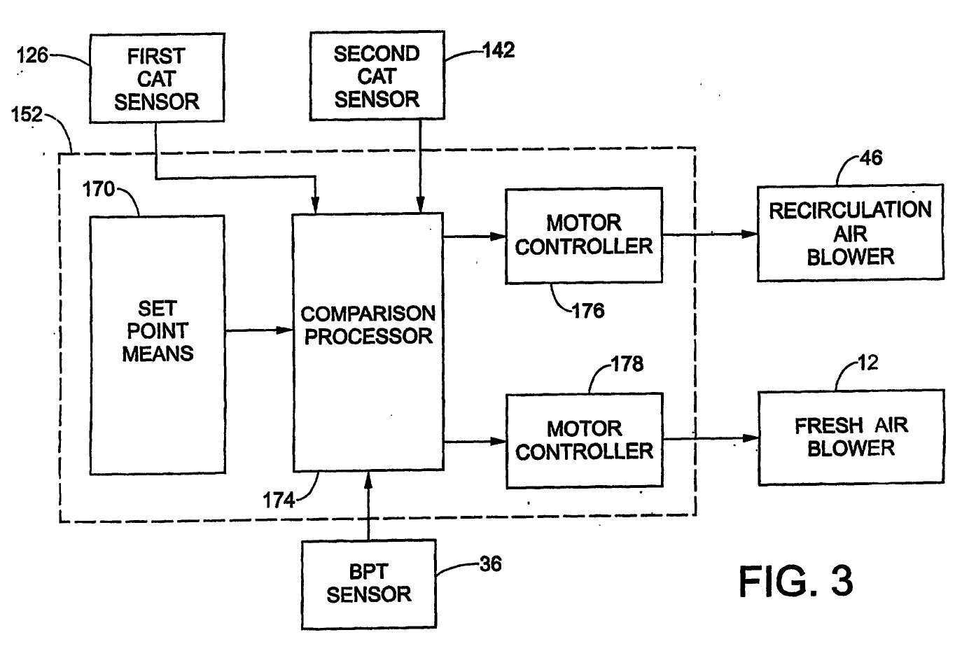

With reference to FIG. 3 and continuing reference to FIG. 2, where like reference numerals refer to like elements, the blower controller 152 includes a set point means 170, which receives and stores the desired temperature parameters such as BPT_{SP} and CAT_{SP}. A comparison processor 174 receives the desired test parameters from the set point means 170 along with CAT readings and BPT readings from the first and second CAT sensors 126, 142 and the BPT sensor 136. As is described more fully below, the comparison processor 174 compares the desired test parameters with the measured parameters and sends motor controller signals to a pair of motor controllers 176, 178, which in turn control the fan speeds of the fresh air blower 112 and the recirculation air blower 146.

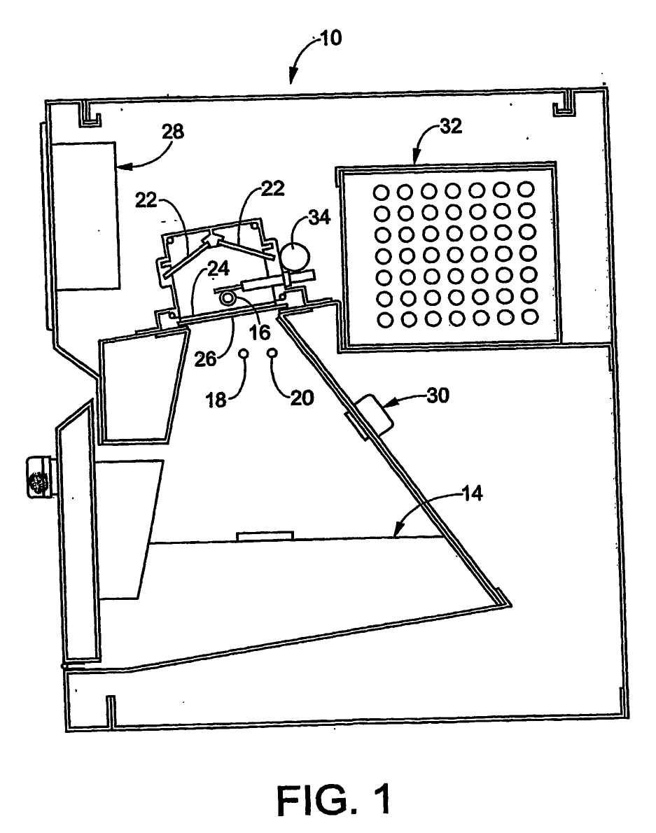

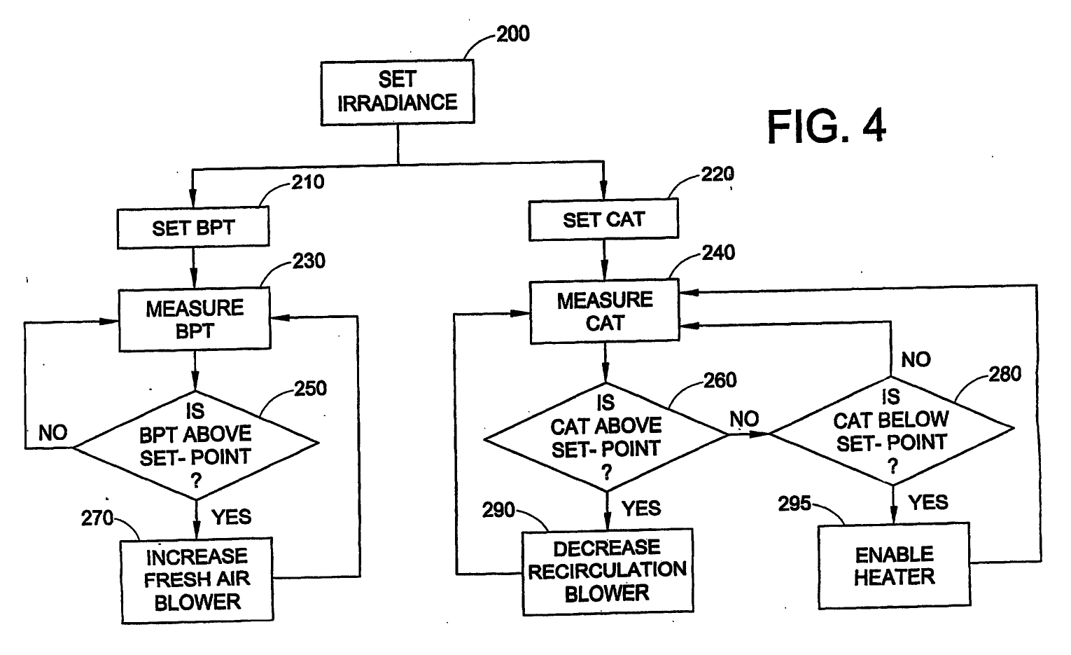

With reference to FIG. 4, once the weathering apparatus is activated, the irradiance is set 200 and controlled to IRR_{SP} by the lamp ballasts 32 (FIG. 1) in a conventional manner. The ballast 32 controls the power delivered to the lamp 16 and can communicate with the switch and timer mechanism 34. Accordingly, the time that the lamp 16 is on can be cycled to simulate day or night cycles, as well as the irradiance of the lamp.

With reference to FIG. 4, the two-blower embodiment illustrated in FIG. 2 is controlled by the blower controller 152. Both the black panel temperature (BPT) and chamber air temperature (CAT) are set 210, 220 for the given test. As air circulates throughout the system, the BPT is measured 230 and compared 250 to the set point to determine whether or not the BPT is above the set point BPT_{SP}. If the BPT is above the set point, the speed of the fresh air blower is increased 270 to compensate for the rise in temperature. That is, more fresh air is drawn into the air mixing duct through the fresh air inlet by the fresh air blower.

Concurrently, the chamber air temperature (CAT) is measured 240 and compared 260, 280 to the CAT set point, CAT_{SP}. More particularly, if the CAT is above the set point, the speed of the recirculation blower is decreased 290. Further, if the CAT is below the set point 280, the air heater is enabled 295. It is to be appreciated that in this embodiment the two blowers are controlled by the blower controller as two automatic closed-loop systems. That is, the speed of the fresh air blower (S_{F}) controls and is determined by the BPT, while the speed of the recirculation air blower (S_{R}) controls and is determined by the CAT. Alternatively, the blower controller controls the two blowers as two automatic closed-loop systems where S_{F} controls and is determined by CAT, while S_{R} controls and is determined by BPT. In this embodiment, as the measured temperatures rise, the respective blowers increase in speed. In this embodiment, the air heater may be used in conjunction with the fresh air blower to provide an additional range for the CAT.

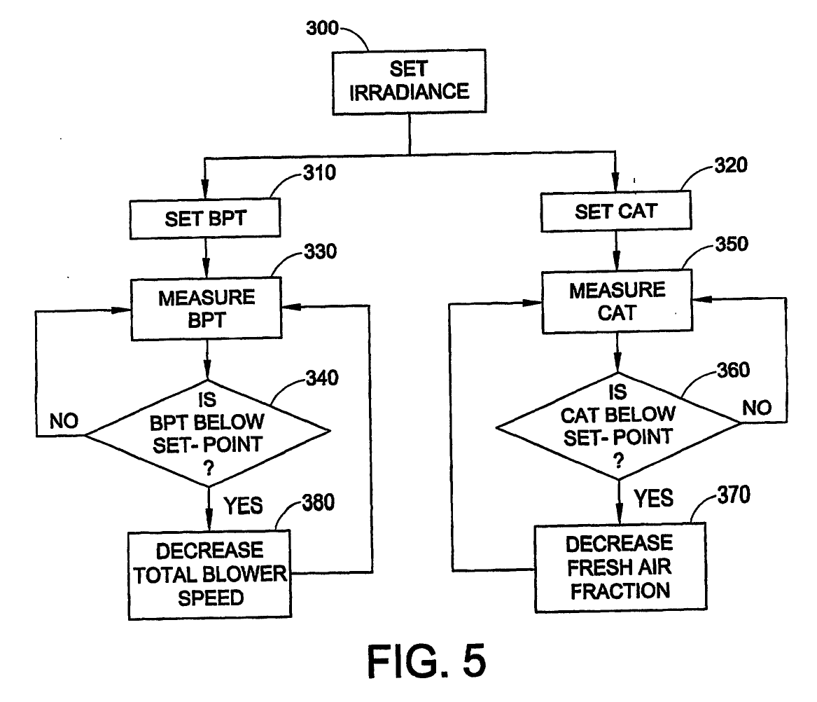

With reference to FIG. 5, in an alternative embodiment, the blower controller controls the two blowers as one automatic closed-loop system, with two outputs to control the two blower speeds. In this embodiment, the total blower speed (S_{TOTAL}=S_{F}+S_{R}) controls and is determined by the black panel temperature (BPT), while the fraction of fresh air (R_{FRESH}=S_{F}/S_{TOTAL}), or a similar weighted ratio controls and is determined by the chamber air temperature CAT.

Initially, the desired irradiance is set 300. In addition, the desired BPT and CAT are set 310, 320. The measured BPT 330 is compared 340 to the set BPT. In addition, the CAT is measured 350 and compared 360 to the CAT set point. In this embodiment, if the BPT is at the set point, and the CAT is below the set point, the fresh air fraction R_{FRESH} is decreased 370, while the total blower speed S_{TOTAL} is held constant. In other words, the speed of the fresh air blower is reduced while the speed of the recirculated air blower is increased. If the BPT is below the set point, while the CAT is at or above the set point, the fresh air fraction remains constant while the total blower speed is reduced 380. In other words, both the fresh air blower speed and the recirculated air blower speed are decreased. In this embodiment, the air heater may be used to increase the range of temperatures that is achievable.

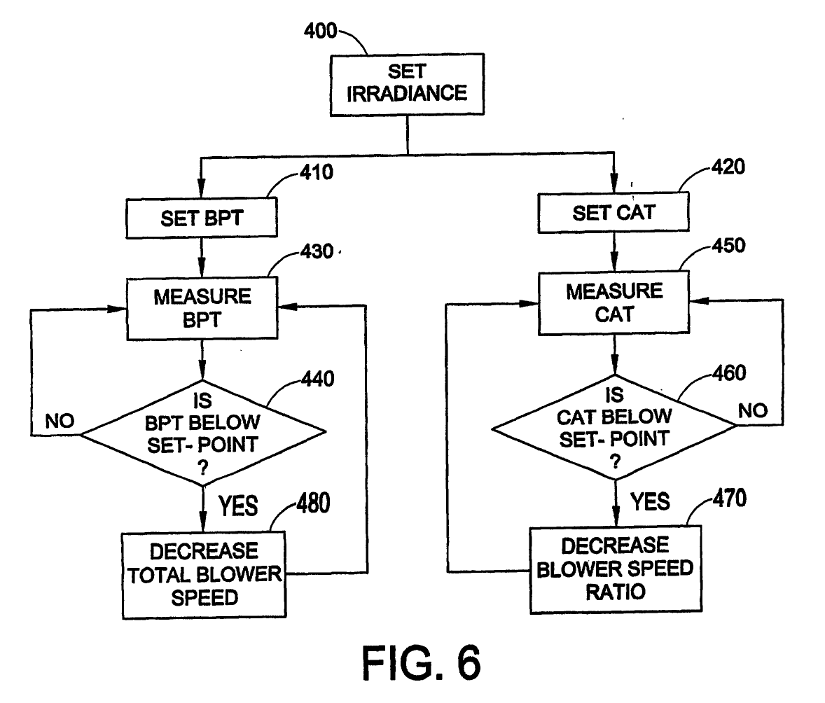

With reference to FIG. 6, in an alternative embodiment, the total blower speed S_{TOTAL} controls and is determined by the BPT, while a blower speed ratio (R_{SPEED}=S_{F}/S_{R}), or a similar weighted ratio (controls and is determined by the CAT.)

The radiance is set 400 to the desired value. In addition, the BPT and CAT are both set 410, 420 to their respective desired values. Both the BPT and CAT are measured 430, 450 and compared 440, 460 to the respective set points. In this embodiment, if the BPT is at the set point, but the CAT is below the set point, S_{TOTAL} is held constant, while the blower speed ratio R_{SPEED} is decreased 470. In other words, the fresh air blower speed S_{F} is reduced, while the recirculated air blower speed S_{R} is increased. Alternately, if the BPT is below the set point, while the CAT is at or above the set point, the blower speed ratio R_{SPEED} remains constant while the total blower speed S_{TOTAL} is decreased, that is, both S_{F} and S_{R} are decreased. In this embodiment, the air heater may be used to increase the range of achievable temperatures.

In an alternative embodiment, the blower controller controls the fresh air blower and the recirculation air blower as two open-loop systems. In this embodiment, the speed of the fresh air blower and the speed of the recirculation air blower are each independently controlled manually, such as with a potentiometer attached to a motor speed controller. By adjusting the two blower speeds, the BPT and CAT of the system are each adjusted, although somewhat interdependently, to fall within specified ranges. If desired, one or more air heaters are employed in conjunction with the fresh air and/or recirculated air blowers to provide a greater range of chamber temperatures.

It is to be appreciated that in any of the above-identified multiple-blower temperature control methods, the blower speeds may be held within fixed maximum and minimum values, and/or within floating maximum and minimum values, depending on the operation of each of the blowers. The floating limits are useful because a minimum speed of one blower may be necessary to block the flow from the other blower passing the wrong way through it. For example, if 100% fresh air is required for a certain test, the fresh air blower spins at the speed which provides the needed airflow. However, if the recirculation air blower is stopped, a significant amount of fresh air reverse flows through the recirculated air blower and out the machine exhaust. To prevent this, the recirculation air blower is operated at a slower “blocking” speed, thereby stopping this leakage and providing the full output of the fresh air blower to the test chamber.

Further, if desired, once the blower speeds are established, the speed of the fresh air blower may be increased by a nominal amount, 10% for example, and the recirculation air blower adjusted to yield the equivalent total flow. In this embodiment, the air heater fine tunes the air temperature, yielding more stable temperatures.

Referring again to FIG. 2, the relative humidity within the test chamber 12 is controlled using a humidity controller 120, which operates manually, semi-automatically, or automatically. The semi-automatic control embodiments require sensing the relative humidity directly, or calculating it using a sensed wet bulb temperature. A feedback mechanism within the humidity controller 120 directs the humidifier 118 to release more humidity as the measured relative humidity falls below the specified relative humidity RH_{SP} or less as the RH exceeds RH_{SP}. The humidifier 118 takes form in at least one of a direct water spray, an air-atomized water spray, a mechanically generated water mist, an ultrasonic fog generation, that is, a nebulizer, or a water boiler. Further, the humidity controller may affect the operation of the two air blowers because relative humidity is “relative” to the air temperature. Therefore, control of the air temperature is important for controlling the relative humidity even if the specified test does not explicitly require temperature control. For example, if the RH is below the set point, the recirculation air blower will recirculate a higher percentage of air in order to retain and increase the relative humidity. In contrast, if the relative humidity is above the RH set point, the fresh air blower draws additional “dry” room air into the mixing air duct, while the recirculation blower recirculates less, and therefor exhausts more, “wet” air from the test chamber.

The apparatus described above provides the user great flexibility in conducting weathering tests on specimens. Tests can be run where the specimen is dosed with a solution that simulates acid rain. For example, the dispensing of solution onto the test specimen can be controlled to dispense so that droplets form on the specimen ranging from one cm to 24 cm (as seen in FIG. 8). Since the specimen is situated substantially horizontally, the solution can puddle, which more accurately simulates the conditions of an automobile trunk, top or hood. Controls are provided to control the dry off period and conditions, in that the lamps can be cycled to simulate day and night, the relative humidity can be controlled to simulate outdoor conditions and the temperature in the chamber can be controlled also to simulate outdoor conditions. By controlling these parameters, the dry off period and conditions can more accurately simulate the environment where the specimens will ultimately end up. Furthermore, the dry off period can be controlled such that the acid solution completely dries of the test specimen anywhere from about one minute to about one week. Accordingly, the resistance of the substrate to a corrosive solution, such as acid rain, can be determined.

The apparatus and method have been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

1. An apparatus for wetting and drying test specimens, the apparatus comprising:
a test chamber;
a lamp capable of generating UV radiation in the test chamber;
a first dispenser adapted to connect to an associated liquid source, the first dispenser being disposed in the test chamber;
a controller in communication with the first dispenser for controlling the dispenser; and
a specimen support disposed in the test chamber for supporting an associated test specimen, wherein the specimen support is disposed in relation to the lamp such that radiation emitted from the lamp contacts the associated specimen supported by the specimen support, wherein the specimen support is disposed in relation to the first dispenser such that liquid dispensed from the first dispenser contacts the associated specimen supported by the specimen support;
a first temperature sensor disposed in or adjacent the test chamber;
a second temperature sensor disposed in or adjacent the test chamber;
a multiple blower system in fluid communication with the test chamber;
a temperature controller in communication with the temperature sensors and the blower system, wherein the controller receives data from the first temperature sensor and the second temperature sensor and controls the blower system in response to the data received from the temperature sensors.

2. The apparatus of claim 1, further comprising a timer in electrical communication with the lamp, whereby the lamp can be cycled to simulate day or night.

3. The apparatus of claim 1, further comprising a humidifier in fluid communication with the test chamber, a humidity sensor in or adjacent the test chamber and a humidifier controller in communication with the humidity sensor and the humidifier.

4. The apparatus of claim 3, further comprising a timer in electrical communication with the lamp, whereby the lamp can be cycled to simulate day or night.

5. The apparatus of claim 1, wherein the lamp comprises a xenon lamp.

6. The apparatus of claim 1, wherein the specimen support is adapted to support the associated test specimen at an angle less than 10° from horizontal.

7. The apparatus of claim 1, further comprising a dimmer in electrical communication with the lamp to control the irradiance of the lamp and an irradiance sensor disposed in the test chamber and in electrical communication with the dimmer.

8. The apparatus of claim 1, further comprising, a heater in communication with the test chamber, wherein the temperature controller is in communication with the heater.

9. The apparatus of claim 8, wherein the first temperature sensor comprises an air temperature sensor and the second temperature sensor comprises a black panel sensor.

10. The apparatus of claim 8, wherein the blower system includes a blower and damper.

11. The apparatus of claim 8, wherein the blower system includes two blowers.

12. The apparatus of claim 11, wherein the temperature controller communicates with one of the two blowers to control the blower in response to data received from the black panel sensor and the temperature controller communicates with the other one of the two blowers to control the other blower in response to data received from the air temperature sensor.

13. The apparatus of claim 11, wherein the temperature controller communicates with heater in response to data received from the air temperature sensor.

14. The apparatus of claim 8, wherein the temperature controller is adapted to control the blower system and heater to allow for the cycling of temperature.

15. The apparatus of claim 1, further comprising a second dispenser adapted to connect to an associated water source.

16. The apparatus of claim 1, wherein the first dispenser comprises a nozzle for spraying the associated test specimens.

17. The apparatus of claim 16, further comprising a timer in electrical communication with the lamp, whereby the lamp can be cycled to simulate day or night.

18. The apparatus of claim 16, further comprising a temperature sensor disposed in or adjacent the test chamber, a heater in communication with the test chamber, a blower system in fluid communication with the test chamber and a temperature controller in communication with the temperature sensor, the heater and the blower system, wherein the temperature controller is adapted to control the blower system and heater to allow for the cycling of temperature.

19. In an accelerated weathering apparatus having a test chamber, a specimen support disposed in the test chamber, a lamp emitting radiation into the test chamber, a timer in electrical communication with the lamp, a temperature sensor disposed in or adjacent the test chamber, an air heater in communication with the test chamber and a fluid dispenser, a method for generating the effect of a corrosive solution on a test specimen, the method comprising:
positioning the test specimen at least substantially horizontally on the specimen support;
wetting the test specimen with a corrosive solution such that drops form on a surface of the test specimen;
selectively emitting radiation from the lamp towards the test specimen; and
controlled drying of the test specimen.

20. The method of claim 19, wherein the step of wetting further comprises spraying the test specimen with the corrosive solution.

21. The method of claim 20, further comprising wetting the test specimen with water.

22. The method of claim 19, wherein the step of controlled drying further comprises controlling the air temperature in the test chamber.

23. The method of claim 22, wherein the step of controlled drying further comprises cycling the air temperature in the test chamber between at least two temperatures.

24. The method of claim 22, wherein the step of controlled drying further comprises controlling the black panel temperature in the test chamber.

25. The method of claim 24, wherein the step of controlled drying further comprises cycling the black panel temperature between at least two temperatures.

26. The method of claim 24, wherein the step of controlled drying further comprises controlling the air temperature and the black panel temperature in the test chamber using a multiple blower system.

27. The method of claim 24, wherein the step of controlled drying further comprises controlling the air temperature and the black panel temperature in the test chamber using a blower and damper system.

28. The method of claim 19, wherein the step of controlled drying further comprises controlling the relative humidity inside the test chamber.

29. The method of claim 19, wherein the step of selectively emitting radiation further comprises emitting UV radiation.

30. The method of claim 29, wherein the step of selectively emitting radiation further comprises cycling the lamp in dark and light cycles.

31. The method of claim 19, wherein the step of wetting the test specimen comprises wetting the test specimen with a solution that simulates acid rain.
